(19) United States
(12) Patent Application Publication
(10) Pub. No.: US 2011/0007001 A1
(43) Pub. Date: Jan. 13, 2011

(54) Dual Mode Input Device

(75) Inventor: Cheng-Lu Liu, Hsin-Chu (TW)

Correspondence Address: SQUIRE, SANDERS & DEMPSEY L.L.P., 275 BATTERY STREET, SUITE 2600, SAN FRANCISCO, CA, 94111-3356, US

(73) Assignee: WALTOP INTERNATIONAL CORPORATION, Hsin-Chu (TW)

(21) Appl. No.: 12/577,139

(22) Filed: Oct. 9, 2009

(30) Foreign Application Priority Data
Jul. 9, 2009 (TW) 098212501

(51) Int. Cl. G06F 3/041

(52) U.S. Cl. 345/173

(57) ABSTRACT

An embodiment of the present invention discloses an input device, which comprises an electromagnetic input unit for inputting by a stylus pen, a touch input unit for inputting by fingers or pen, a first micro controller for controlling the electromagnetic input unit, a second micro controller for controlling the touch input unit, and a major controller for controlling the first and second micro controller.

### FIELD OF THE INVENTION

The present invention relates to an input device, and more particularly, to a dual mode input device.

### DESCRIPTION OF THE PRIOR ART

Tablet, digitizer, and white board all are similar kind of products; they have two major inputting methods: electromagnetic induction method and touch panel method. The former method typically employs a stylus pen for assisting the user's input.

For inputting data, the user holds the stylus pen to write or draw on the writeable surface of the input device or pushes one or more buttons or switches of the stylus pen. An x-y loop antenna array is arranged inside the writable surface of the input device to sense electromagnetic waves radiated from the stylus pen. The antenna nearest to the stylus pen will sense the biggest amplitude among all received electromagnetic waves so that the coordinate of the stylus pen can be estimated. In addition, when the stylus pen touches the writeable surface of the input device, the frequency of an oscillating circuit of the input device will be changed because its inductance is changed. The greater is the pressure of the stylus pen exerted to the writable surface, the greater is the inductance. The greater is the inductance, the greater is variance of the frequency of the oscillating circuit. Therefore, the variation of the pressure exerted to the writable surface can be estimated by checking the variation of the frequency of the oscillating circuit. In addition, the push buttons or switches are pressed down then recovered, such that vary the capacitance as well, and thus vary the frequency of the oscillating circuit. Checking the variation of frequency of the oscillating circuit can recognize which push button or switch that the user pressed.

On the other hand, the touch panel typically comprises a polymer substrate, a glass substrate, and a lot of spacers are sandwiched between the two substrates. Both the polymer substrate and the glass substrate comprise a conducting layer arranged between the spacers and the substrate. When the user touches the polymer substrate, the conducting layer of the polymer substrate will contact the conducting layer of the glass substrate due to the compression of the spacers, such that the electrical connection of the two conducting layers is established and the electrical connection provides some information for the input device, such as the capacitance or the resistance, and then a processing unit such as a computer is employed to estimate the coordinate of the touch position according to the information.

Both of the two above input methods have advantages and disadvantages. Input devices using the electromagnetic method have superior resolution; however the operation must cooperate with the stylus pen. In contrast, input devices using the touch panel can input data by the fingers in place of the stylus pen, but the resolution cannot reach 500 dpi or more. In addition, the conventional touch panel cannot simultaneously input two or more data, that is, two or more coordinates.

Therefore, it would be advantageous to provide an input device that includes all advantages of the two input methods.

### SUMMARY OF THE INVENTION

The object of the present invention is to provide an input device that has both advantages of the electromagnetic induction mode and the touch panel mode; in addition, the resolution of touch panel mode can be promoted.

According to the object, one embodiment of the present invention provides an input device that comprises an electromagnetic input unit for inputting data by a stylus pen, a touch input unit for inputting data by touch of one or more user's fingers or other devices, a first micro controller for controlling the electromagnetic input unit and obtaining coordinates of the stylus pen, a second micro controller for controlling the touch input unit and obtaining coordinates of the one or more fingers or other devices, a major controller for controlling the first micro controller and the second micro controller and obtaining coordinates from the first micro controller and the second micro controller, and a computer for processing coordinates transmitted from the major controller.

### BRIEF DESCRIPTION OF THE DRAWINGS

FIG. 1 shows a dual mode input device according to one embodiment of the present invention

FIG. 2 shows the structure of an input device according to one embodiment of the present invention.

FIG. 3 shows an infrared touch input structure according to another embodiment of the present invention.

FIG. 4 shows an infrared touch input structure according to another embodiment of the present invention.

FIG. 5A and FIG. 5B show the detail of structure and method of the touch input unit of FIG. 2 according to one embodiment of the present invention.

FIG. 6A and FIG. 6B describe the method to avoid the “ghost input” according to another embodiment of the present invention.

FIG. 7 shows a procedure executed by the major controller to obtain the user's inputting coordinates or other information according to one embodiment of the present invention.

### DESCRIPTION OF THE PREFERRED EMBODIMENT

Reference will now be made in detail to specific embodiments of the invention. Examples of these embodiments are illustrated in accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a through understanding of the present invention. The present invention may be practiced without some or all of these specific details. In other instances, well-known components and process operations are not described in detail in order not to unnecessarily obscure the present invention. While drawings are illustrated in details, it is appreciated that the quantity of the disclosed components may be greater or less than that disclosed, except expressly restricting the amount of the components.

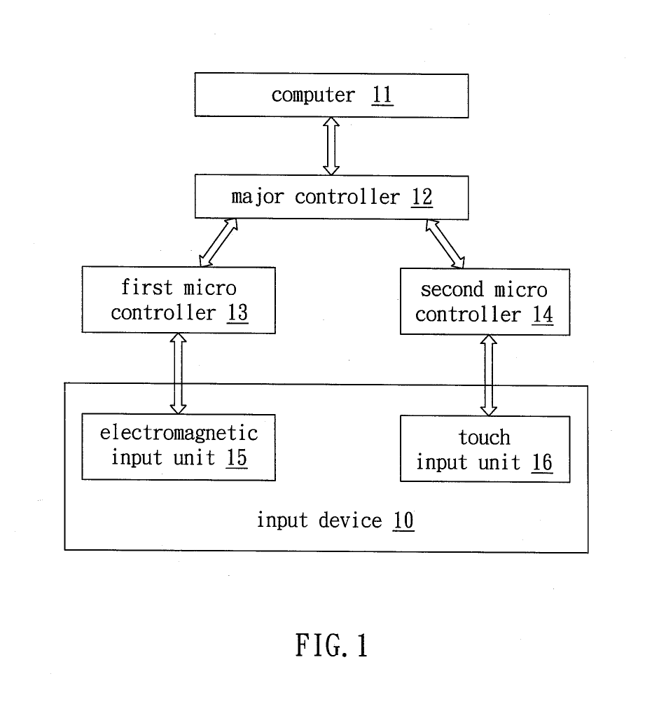

FIG. 1 shows a dual mode input device 10 according to one embodiment of the present invention. The dual mode input device 10 comprises an electromagnetic input unit 15 and a touch input unit 16. Typically the input device 10 is cooperated with a computer 11, a major controller 12, a first micro controller 13, and a second micro controller 14. The user can input data via the electromagnetic input unit 15 by using a stylus pen (not shown) or via the touch input unit 16 by using pen, one or more fingers, and the likes. The major controller 12 is employed to detect which input method that the user is used, and to control the first micro controller 13 and the second micro controller 14. The first micro controller 13 is used for controlling the electromagnetic input unit 15 and acquiring the coordinate and pressure information of the stylus pen. The second micro controller 14 is used for controlling the touch input unit 16 and acquiring the coordinate information via the touch method. The computer processes the coordinate and pressure information and shows the track of the user's input by a projector or other devices.

The connection between the major controller 12 and other components such as computer 11 may be wiring or wireless. For example, the connection may comprise Universal Serial Bus, Electronic Industries Alliance (EIA) RS-232, Bluetooth, Wireless, and the likes. In addition, the first micro controller 13 and the second micro controller 14 may be incorporated into the major controller 12. Even the major controller 12, the first micro controller 13, and the second micro controller 14 can all be incorporated into the computer 11. These modifications can be easily made by a person skilled in the art and belong to the scope of the present invention.

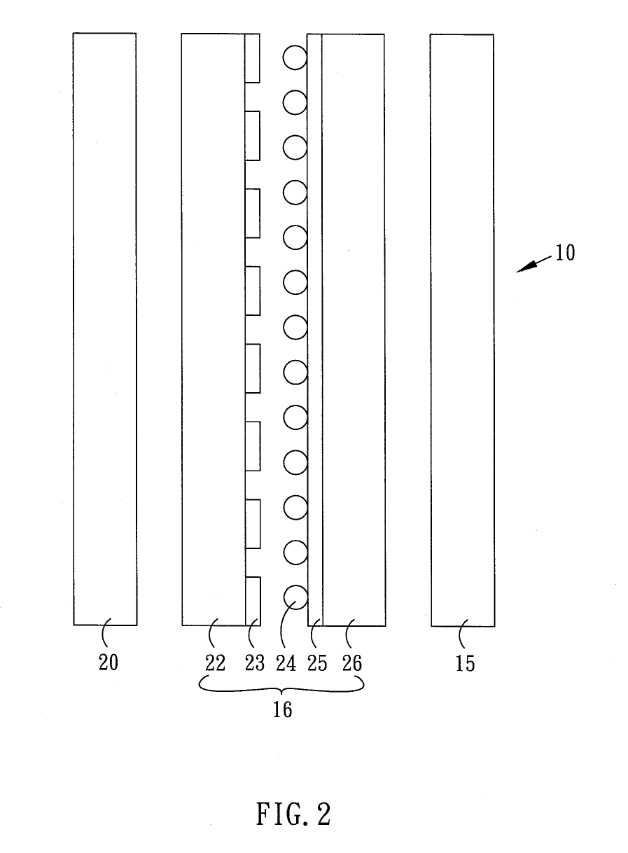

FIG. 2 shows the input device 10 according to one embodiment of the present invention. The input device 10 comprises a writable surface 20, the electromagnetic input unit 15, and the touch input unit 16. The user employs the writable surface 20 for writing and drawing. A XY-antenna array (not shown) is arranged inside the electromagnetic input unit 15 to receive electromagnetic waves radiated from the stylus pen. When the user holds the stylus pen to write or draw on the writable surface 20 or presses the buttons or switches of the stylus pen, the first micro controller 13 switches the antennas of the XY-antenna array to sense the electromagnetic waves and estimates—the coordinate of the stylus pen, the pressure that the stylus pen exerts on the writable surface 20, and the button or switch that the user presses—according to the amplitude or the frequency variance of the received electromagnetic waves. According to the present invention, the electromagnetic input unit 15 is not limited to the above-mentioned structure; any well-known, existent, or on-developing electromagnetic induction structure can be employed by the present invention. For example, the electromagnetic input unit 15 may employ the structure and method described in Taiwan Patent issued no. 1266244 or Taiwan Patent published no. 200539006. The two patents are herein incorporated by reference.

In addition, the touch input unit 16 shown in the embodiment of FIG. 2 comprises a first substrate 22 and a second substrate 26, and both of them are made of an electrical insulated material, such as Polyethylene Terephthalate or the likes, or, the two substrates may be made two different materials respectively. In addition, a first conducting circuit 23 is arranged on a surface of the first substrate 22 facing to the second substrate 26; similarly, a second conducting circuit 25 is arranged on a surface of the second substrate 26 facing to the first substrate 22, and a lot of spacers 24 are arranged between the first conducting circuit 23 and the second conducting circuit 25. When the user employs finger, pen, or other devices to touch the writable surface 20 at a location, the first conducting circuit 23 will contact the second conducting circuit 25 and provides voltage or other information to the second micro controller 14, such that the coordinate of the location that the user touches can be estimated.

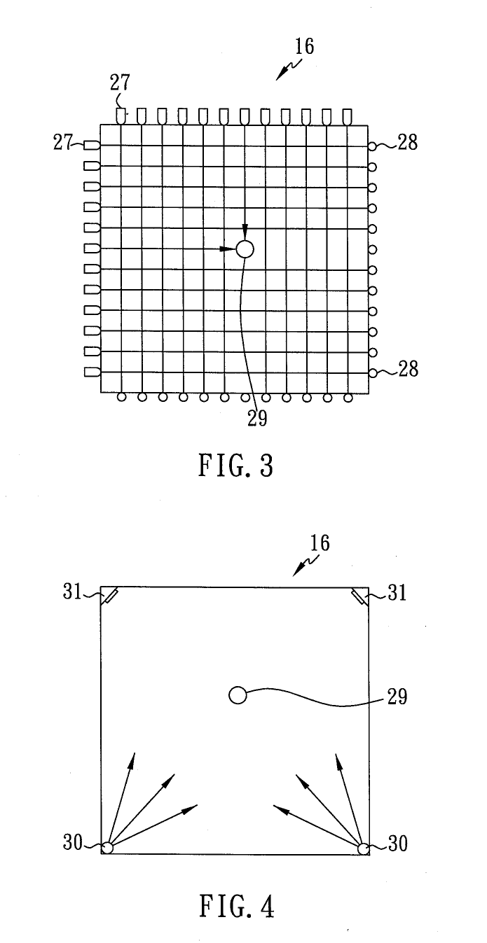

According to the present invention, the touch input unit 16 may employ other structures different from the above-mentioned structure. For example, the infrared touch input structure may be used as the touch input unit 16. FIG. 3 and FIG. 4 show two examples of the infrared touch input structure according to other embodiments of the present invention. As shown in FIG. 3, the touch input unit 16 comprises a plurality of directional infrared emitters 27 and a plurality of infrared receivers 28, which are arranged along the X-coordinate and Y-coordinate of the input device respectively, and one emitter 27 corresponds to one receiver 28. The user touches the writable surface 20 to result one (or more) touching point 29. The touching point 29 hinders the infrared ray to be transmitted to a specific infrared receiver 28 at X-coordinate and Y-coordinate respectively, such that the coordinate of the touching point(s) 29 can be estimated. As shown in FIG. 4, the touch input unit 16 comprises a plurality of infrared emitters 30 and a plurality of image sensors 31 respectively arranged at the corners (and/or other locations) of the input device. The image sensor 31 may be Charge-Coupled Device (CCD) or Complementary Metal-Oxide-Semiconductor (CMOS). Similarly, the touching point 29 makes the received image at each image sensor 31 being different, such that the coordinate of the touching point(s) 29 can be estimated.

The above-mentioned electromagnetic input unit 15 and the touch input unit 16 have individual control circuit, and the two control circuits could be incorporated into a substrate, for example, a printed circuit board of the electromagnetic input unit 15, to lower the thickness of the input device.

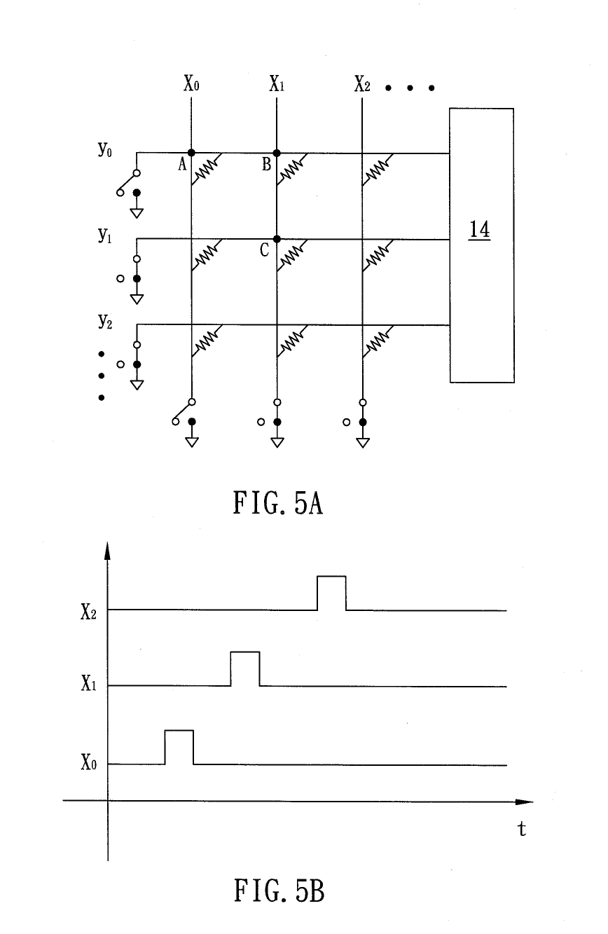

FIG. 5A and FIG. 5B show the detail of structure and method of the touch input unit 16 of FIG. 2 according to one embodiment of the present invention. In this exemplary example, x0, x1, x2 . . . are independent conducting wires and denote the above-mentioned first conducting circuit 23; y0, y1, y2 . . . are independent conducting wires and denote the above-mentioned second conducting circuit 25. The second conducting wire y0, y1, y2 . . . are connected to the second micro controller 14. In another embodiment of the present invention, x0, x1, x2 . . . denote the second conducting circuit 25 and y0, y1, y2 . . . denote the first conducting circuit 23. When the touch input unit 16 is operated, a constant voltage is provided to the x0, x1, x2 . . . in sequence, as shown in FIG. 5B. As shown FIG. 5A, when the constant voltage is exerted on the x0, the wire x0 is floated and the other wires x1, x2 . . . are grounded. And then y0, y1, y2 . . . will be checked in sequence whether an electrical connection is established. When y0 is checked, y0 is floated and y1, y2 . . . are grounded (as the situation shown in FIG. 5A); when y1 is checked, y1 is floated and y0, y2, y3 . . . are grounded, and so on. The same procedure will be repeated when the constant voltage is exerted on the x1, at this time x0 being floated, x1, x3, x4 . . . being grounded, and then y0, y1, y2 . . . will be checked in sequence whether an electrical connection is established.

The user may input one or more points (coordinates) at the writable surface 20. For example, when the user touches point A, B, and C in FIG. 5A, three analog voltage values will be detected in sequence at wires y0 and y1 because they are connected with the wires x0 and x1. The three analog voltage values are converted to three digital voltage values via an analog-to-digital converter (not shown). The coordinates of point A, B, and C can be estimated by information provided by the three digital voltage values. For example, the information may comprise to assume the coordinate of points (x0, y0), (x1, y0), and (x1, y1) equaling a value 1, and the other coordinates of points equaling 0, and then the information is transmitted via the second micro controller 14.

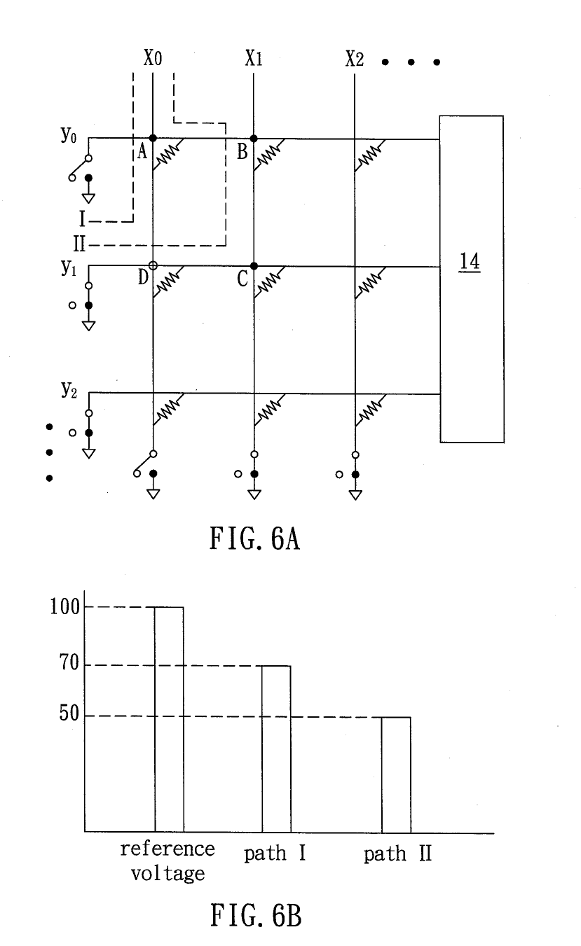

The structure and method described in FIG. 5A and FIG. 5b can avoid a conventional deficiency “ghost input”, that is, the user does not touch a point (coordinate), but the input device misjudges that the user inputs this point. FIG. 6A and FIG. 6B describe the method to avoid the “ghost input”. As shown in FIG. 6A, when the user touches points A, B, and C, point D could be a “ghost input”. Normally, the coordinate (x0, y1) equals 1 only if the conducting path I is established; however, the point D is a “ghost input” when the conducting path II is established, that is, the user touching the point A, B, and C simultaneously. The method to avoid the “ghost input” is to normalize the digital voltage value of the normal path and the abnormal path via a reference voltage, and then compare it, as shown in FIG. 6B. Because the abnormal path (for example, path II) is inevitably longer than the normal path (for example, path I), the normalized digital voltage value of abnormal path II (70) is inevitably smaller than the digital voltage value of normal path (50). Therefore, it can be used to judge that point D is “ghost input” rather than user's input.

In the embodiment shown in FIG. 6A and FIG. 6B, the accuracy and sensitivity of the touch input unit 16 will depend on the material of the first conducting circuit 23 and the second conducting circuit 25. In a preferred embodiment of the present invention, the first conducting circuit 23 and the second conducting circuit 25 are made of colloidal carbon and carbon.

According to the present invention, the first conducting circuit 23 and the second conducting circuit 25 are unnecessary to be orthogonal with each other. The layout can adapt to the shape, size, and resolution of the input device 10. A plurality of grids, for example points A, B, and C shown in FIG. 5A, are constructed by crossing the first conducting circuit 23 with the second conducting circuit 25. The grids provide the connecting points of the first conducting circuit 23 and the second conducting circuit 25.

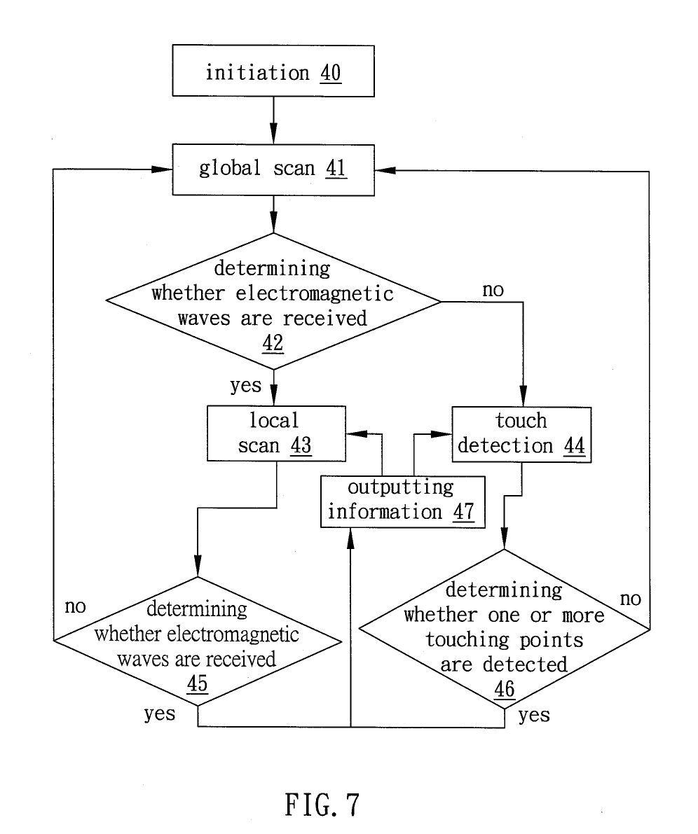

FIG. 7 shows a procedure executed by the major controller 12 to obtain the user's inputting coordinates or other information. Step 40, initiation, comprising parameter setting, is executed after the input device is started. Step 41, global scan, this step assume that the user selects the electromagnetic input method so that a global scan is executed to obtain the initial position of the stylus pen. Step 42, the major controller 12 determines whether electromagnetic waves are received after the global scan 41. In response to the electromagnetic waves being received, a local scan, i.e., step 43, is executed to track the inputting coordinates of the stylus pen; in response to the electromagnetic waves being not received, a touch detection, i.e., step 44, is executed to track the inputting coordinates that the user touches. In addition, step 45 follows step 43 to determine whether electromagnetic waves are received. In response to the electromagnetic waves being received, outputs information (coordinates, pressure, and the likes) to the first micro controller 13 and continues the step 43 local scan; in response to the electromagnetic waves being not received, back to step 41 global scan. Similarly, step 46 follows step 44 to determine whether one or more touching points are detected. In response to the one or more touching points being received, outputs information (coordinates, pressure, and the likes) to the first micro controller and then continues the step 44 touch detection; in response to the one or more touch points being not received, back to step 41 global scan.

It is appreciated that because the “global scan” and “local scan” are well known in the art, the detail description of which are omitted. In addition, the touch detection 44 may comprise any one of methods described in the previous embodiments. In addition, the above procedure executed by the major controller may be executed in a different order. For example, the step 44 and step 46 may be prior to step 41 in another embodiment of the present invention.

According to the input device of the present invention, user can input data by electromagnetic induction mode or touch input mode, wherein the touch input mode can input one or more data simultaneously, and the resolution is increased by increasing the layout density of the first and second conducting circuits; therefore, the input device provided by the present invention not only has the advantage of both electromagnetic induction and touch detection, but also promote the performance of the input device.

Although specific embodiments have been illustrated and described, it will be appreciated by those skilled in the art that various modifications may be made without departing from the scope of the present invention, which is intended to be limited solely by the appended claims.

What is claimed is:

1. An input device, comprising:
an electromagnetic input unit, for inputting data by a stylus pen;
a touch input unit, for inputting data by touch of one or more user's fingers or other devices;
a first micro controller, for controlling said electromagnetic input unit and obtaining coordinates of the stylus pen;
a second micro controller, for controlling said touch input unit and obtaining coordinates of the one or more fingers or other devices;
a major controller, for controlling said first micro controller and said second micro controller and obtaining coordinates from said first micro controller and said second micro controller; and
a computer, for processing coordinates transmitted from said major controller.

2. The input device as claimed in claim 1, wherein said input device further comprises a writable surface for writing and drawing by the user, said electromagnetic input unit comprises an XY-antenna array to receive electromagnetic waves radiated from the stylus pan, and said first micro controller switches the antennas of the XY-antenna array to sense the electromagnetic waves and estimate the coordinates of the stylus pen, the pressure that the stylus pen exerts on the writable surface, and a button or switch of the stylus pen that the user presses according to the amplitude or the frequency variance of the received electromagnetic waves.

3. The input device as claimed in claim 1, wherein said touch input unit comprises a first substrate and a second substrate, wherein the first substrate and the second substrate are made of an electrical insulated material, a first conducting circuit is arranged on a surface of the first substrate facing to the second substrate, a second conducting circuit is arranged on a surface of the second substrate facing to the first substrate, and a lot of spacers are arranged between the first conducting circuit and the second conducting circuit.

4. The input device as claimed in claim 3, wherein the first substrate and the second substrate are made of polyethylene terephthalate.

5. The input device as claimed in claim 3, wherein the first conducting circuit and the second conducting circuit are made of colloidal carbon and carbon.

6. The input device as claimed in claim 3, wherein the first conducting circuit and the second conducting circuit respectively comprise a plurality of independent wires, the first conducting circuit intersects the second conducting circuit to form a plurality of grids, and said second micro controller provides a constant voltage to the wires of the first conducting circuit in sequence and then checks the voltage of each wire of the second conducting circuit in sequence, when the user's finger or other devices touch one or more of the grids, one or more analog voltage values are detected and converted and normalized to digital voltage values via a analog-to-digital converter, the coordinates of the touched grids being estimated by the one or more digital voltage values.

7. The input device as claimed in claim 1, wherein both said electromagnetic unit and said touch input unit further comprises a control circuit, and the two control circuits are incorporated into a printed circuit board.

8. The input device as claimed in claim 1, wherein said touch input unit comprises a plurality of directional infrared emitters and a plurality of infrared receivers, one said receiver corresponds to one said emitter, the user's one or more touch points hinders one or more infrared rays radiated from one or more of said emitters to their corresponding receivers, such that the coordinates of the one or more touching point can be estimated.

9. The input device as claimed in claim 1, wherein said touch input unit comprises a plurality of infrared emitters and a plurality of image sensors, the user's one or more touching point makes the received images of the image sensors different, such that the coordinate of the one or more touching points can be estimated.

10. The input device as claimed in claim 1, wherein said input device display the track of the user's input via a projector.

11. The input device as claimed in claim 1, wherein said major controller and said computer are connected in a wire or wireless manner.

12. The input device as claimed in claim 1, wherein said major controller executes a procedure for controlling said first micro controller and said second micro controller, said procedure comprising the steps of:
initiating;
global scanning, for obtaining the initial position of the stylus pen;
determining whether electromagnetic waves are received after the global scan, in response to the electromagnetic waves being received, a local scan being executed to track the inputting coordinates of the stylus pen; in response to the electromagnetic waves being not received, a touch detection being executed to track the inputting coordinates that the user touches;
determining whether electromagnetic waves are received after the local scan, in response to the electromagnetic waves being received, outputting information and continues the local scan; in response to the electromagnetic waves being not received, backing to global scan; and
determining whether one or more touching points are detected, in response to the one or more touching points being received, outputting information and continuing touch detection; in response to the one or more touch points being not received, backing to global scan.
